(19) United States
(12) Patent Application Publication
(10) Pub. No.: US 2003/0167641 A1
(43) Pub. Date: Sep. 11, 2003

(54) Blade clamp device for jig saws

(76) Inventor: Cheng I Teng, Feng Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/092,568

(22) Filed: Mar. 8, 2002

(51) Int. Cl. B27B 19/09; B23D 49/10

(52) U.S. Cl. 30/337; 30/392

(57) ABSTRACT

A blade clamp device for jig saws includes a drive shaft with a holder connected to a lower end of the drive shaft. A recess is defined in an outer surface of the holder for receiving a blade. A lug extends radially outward from the holder. A C-shaped clamp member is pivotally connected to the lug and a torsion spring is mounted to the pin, one end of the spring is engaged with the lug and the other end of the torsion spring is engaged with an inside of the clamp member. A pressing member extends from an inside of the clamp member so as to contact the blade in the recess.

### FIELD OF THE INVENTION

The present invention relates to a blade clamp device for jig saw and includes a rotatable clamp with a protrusion which clamp the blade in position so that various types of blades can be clamped.

### BACKGROUND OF THE INVENTION

A conventional clamp device for positioning the blade of a jig saw is shown in FIG. 9 and generally includes a recess 61 defined in a lower end of the drive shaft 60 of the jig saw and an end of the blade 80 is inserted in the recess 61. A passage is defined in the drive shaft 60 laterally and a positioning bolt 70 is inserted in the passage and securely contacts the blade 80 in the recess 61. By the positioning bolt 70, the blade 80 is securely positioned. However, the recess 61 can only receive the blade 80 which has a thickness located in a specific range. The movement of the blade 80 is perpendicular to the clamp force of the positioning bolt 70 so that the blade 80 is easily loosened during the operation of the jig saws. Besides, when replacing the blade 80, a screw driver is needed to unscrew the positioning bolt 70.

The present invention intends to provide a blade clamp device that can clamp blades have different sizes of thickness.

### SUMMARY OF THE INVENTION

In accordance with one aspect of the present invention, there is provided a blade clamp device for jig saws and the blade clamp device comprises a drive shaft wherein a holder is connected to a lower end of the drive shaft and has a recess defined in an outer surface thereof for receiving a blade therein. A lug extends radially outward from the holder. A C-shaped clamp member is pivotally connected to the lug by a pin and a pressing member extends from an inside of the clamp member. A torsion spring is mounted to the pin and a first end of the torsion spring is engaged with the lug and a second end of the torsion spring is engaged with the inside of the clamp member.

The primary object of the present invention is to provide a blade clamp device for jig saws wherein the clamp member is pivotably mounted to the blade holder and has a pressing member to press the blade in position.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a jig saw that is equipped with the blade clamp device of the present invention;

FIG. 2 is a perspective view to show the blade clamp device of the present invention;

FIG. 3 is an exploded view to show the blade clamp device of the present invention;

FIG. 4 is an exploded view to show a blade and the holder of the blade clamp device of the present invention;

FIG. 5 shows the blade is to be put in the recess in the holder of the blade clamp device of the present invention;

FIG. 6 is a perspective view to show the blade is clamped in the blade clamp device of the present invention;

FIG. 7 is a perspective view form another angle to show the blade clamp device of the present invention;

FIG. 8 is a bottom view to show the blade clamp device of the present invention, and

FIG. 9 is a cross sectional view to show a blade is clamped by a conventional blade clamp device.

### DETAILED DESCRIPTION OF THE PREFERRED EMBODIMENT

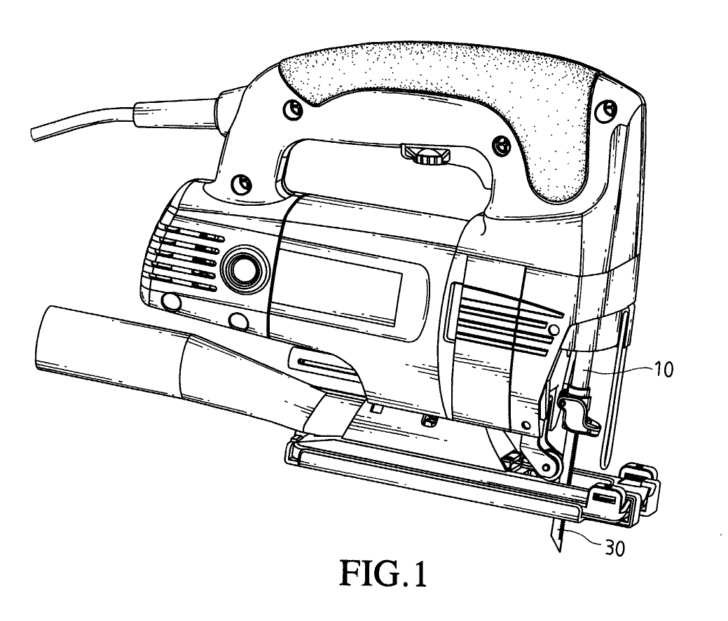

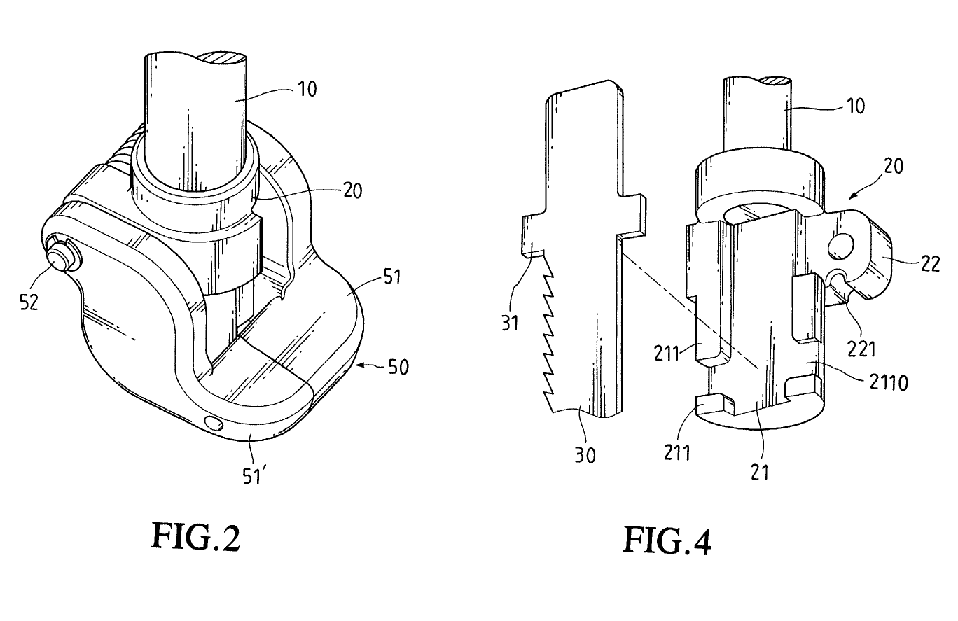

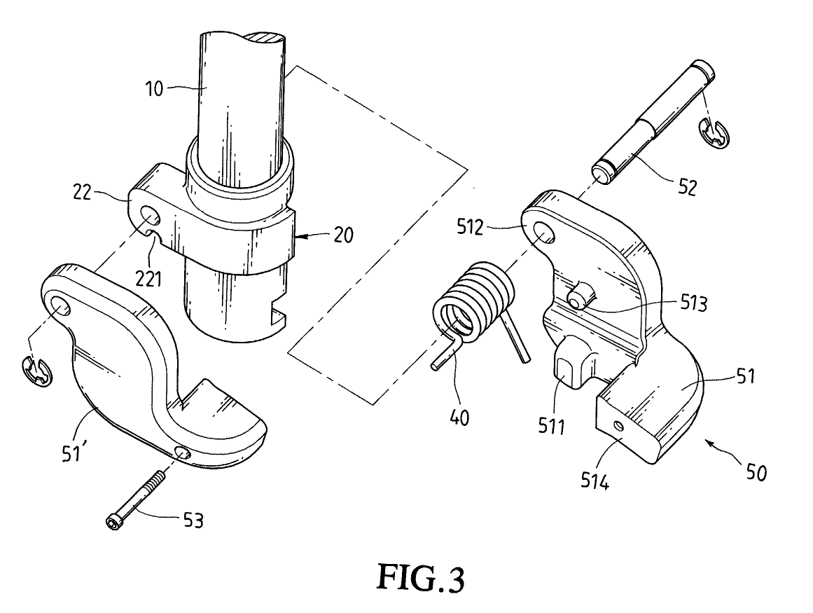

Referring to FIGS. 1 to 3, the blade clamp device for jig saws of the present invention comprises a drive shaft 10 and a holder 20 is connected to a lower end of the drive shaft 10. The holder 20, referring to FIG. 4, has an engaging surface defined in an outer surface thereof and two side rails 211 extend from two sides of the engaging surface so as to define a recess 21. A top end of a blade 30 is received in the recess 21 and two wings 31 of the blade 30 are engaged with two notches 2110 in the two rails 211. A lug 22 extends radially outward from the holder 20 and a hole is defined through the lug 22.

A C-shaped clamp member 50 composed of a first part 51 and a second part 51′ is pivotally connected to the lug 22 by a pin 52 extending through the hole in the lug 22 and the two respective first ends 512 of the first part 51 and the second part 51′. The other two respective second ends 514 of the first part 51 and the second part 51′ are connected by a screw 53. A pressing member 511 and a protrusion 513 respectively extend from an inside of the clamp member 50.

A positioning member which can be a torsion spring 40 is mounted to the pin 52 and a first end of the torsion spring 40 is engaged with a notch 221 defined in a lower end of the lug 22 and a second end of the torsion spring 40 is engaged with the protrusion 513 on the inside of the clamp member 50.

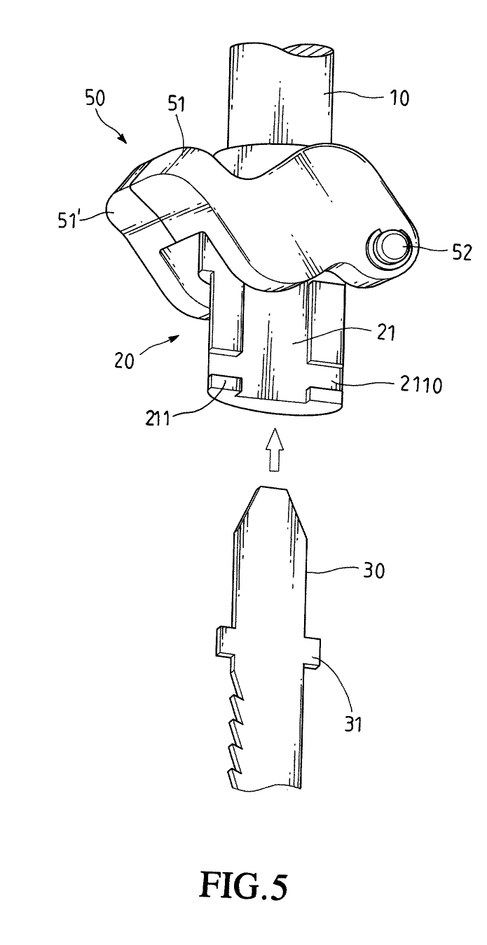

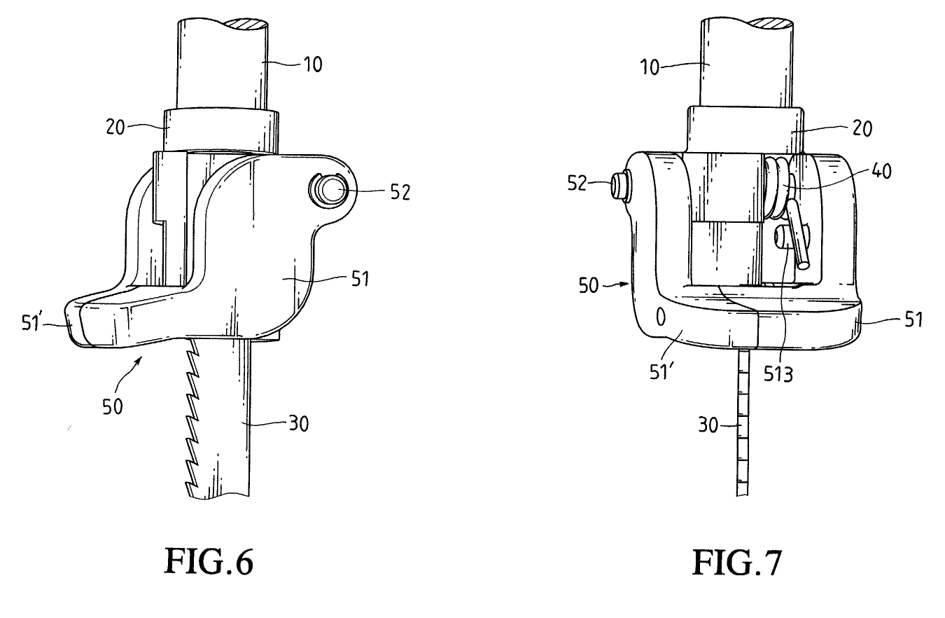

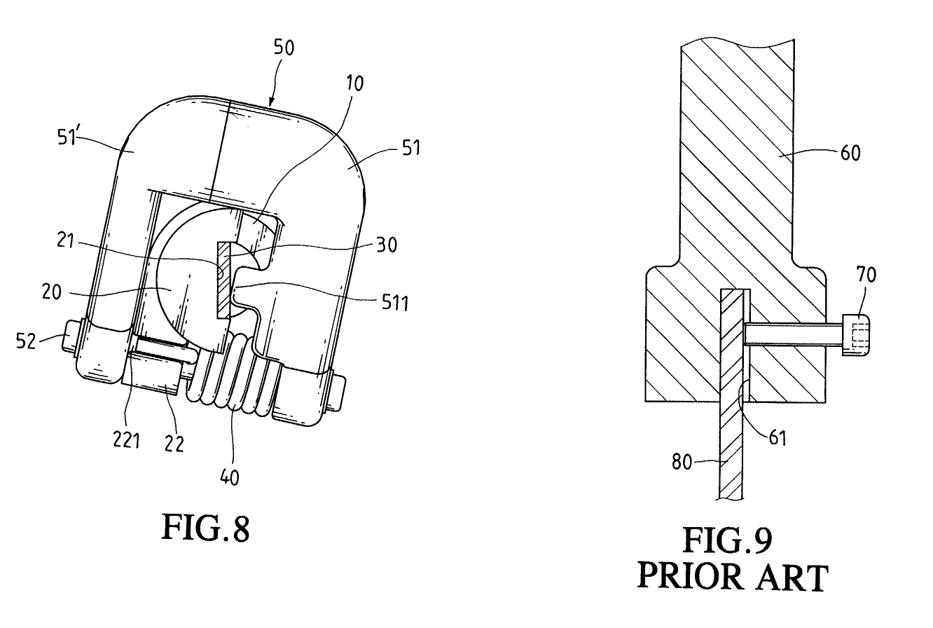

When pivoting the clamp member 50 upward as shown in FIG. 5, the recess 21 is exposed and the top end of the blade 30 is easily received in the recess 21. When releasing the clamp member 50 which is pivoted downward by the torsion spring 40 as shown in FIGS. 6 to 8. The pressing member 511 then securely contacts the top end of the blade 30 to position the blade 30. It is to be noted that the clamp feature is controlled by the torsion spring 40 so that the clamp device can clamp the blades 80 with different sizes of thickness without other tools.

While we have shown and described the embodiment in accordance with the present invention, it should be clear to those skilled in the art that further embodiments may be made without departing from the scope of the present invention.

What is claimed is:

1. A blade clamp device for jig saws, comprising:
a drive shaft;
a holder connected to a lower end of the drive shaft and having an engaging surface defined in an outer surface thereof, a recess defined in the engaging surface of the drive shaft and being adapted to receive a blade, a lug extending radially outward from the holder;
a C-shaped clamp member pivotally connected to the lug by a pin extending through two ends of the clamp member and the lug, a pressing member extending from an inside of the clamp member and adapted to contact the blade, and
a positioning member for securely positioning the clamp member onto the holder.

2. The device as claimed in claim 1 wherein the positioning member is a torsion spring mounted to the pin, a first end of the torsion spring engaged with the lug and a second end of the torsion spring engaged with the inside of the clamp member.

3. The device as claimed in claim 2 further comprising a notch defined in a lower end of the lug so that the first end of the torsion spring is engaged with the notch, a protrusion extending from the inside of the clamp member and the second end of the torsion spring being engaged with the protrusion.

4. The device as claimed in claim 1, wherein the clamp member is composed of a first part and a second part, two respective first ends of the first part and the second part connected together by a screw and two respective second ends of the first part and the second part pivotally connected to the lug by the pin.
